(19) United States
(12) Patent Application Publication
(10) Pub. No.: US 2014/0314116 A1
(43) Pub. Date: Oct. 23, 2014

(54) CALIBRATOR FOR CALIBRATING TEMPERATURE MEASUREMENT DEVICES

(71) Applicant: SIKA Dr. Siebert & Kühn GmbH & Co. KG, Kaufungen (DE)

(72) Inventor: Michael Rehm-Gumbel, Niedenstein (DE)

(73) Assignee: SIKA Dr. Siebert & Kühn GmbH & Co. KG, Kaufungen (DE)

(21) Appl. No.: 14/256,021

(22) Filed: Apr. 18, 2014

(30) Foreign Application Priority Data
Apr. 18, 2013 (EP) 13 002 050.6

(51) Int. Cl. G01K 15/00

(52) U.S. Cl. CPC G01K 15/005
USPC 374/1

(57) ABSTRACT

A calibrator is provided for calibrating devices with a temperature function, e.g. thermometers or thermal switches. The calibrating device includes a calibrator block with a cavity for the purpose of receiving a receiving body for at least one temperature measurement device to be calibrated. The calibrator block features a material with thermally insulating properties and the receiving body features a material with thermally conductive properties. At least one heating device is embedded in the calibrator block in the area of the cavity.

### CROSS-REFERENCE TO RELATED APPLICATION

This application claims priority of European Patent Application No. EP 13 002 050.6, filed Apr. 18, 2013, the content of which is incorporated herein in its entirety.

### FIELD OF THE INVENTION

The invention relates to a calibrator for calibrating devices with a temperature function, e.g. thermometers or thermal switches, with a calibration device. In the following, devices with a temperature function are to be understood as devices, the operation of which is based on determining a temperature, i.e., as explained, a thermometer or a thermal switch for example.

### BACKGROUND OF THE INVENTION

A calibration device of a calibrator is known from the prior art. This calibration device usually contains a so-called dry chamber. A dry chamber is a cavity disposed in a calibrator block, into which a metallic receiving body is insertable, this metallic receiving body serving to receive the equipment to be calibrated. It is essential that the calibrator block, as well as the receiving body, is respectively made of a material with good thermal conductivity, usually metal. The purpose of this measure is maintaining a uniform, i.e. homogenous temperature distribution in the receiving body located in the calibrator block. In this context, reference is made to US 2007/0291814 A1, which describes calibrator blocks and the receiving bodies received by the calibrator blocks made of metallic materials. Here, the heating devices are disposed in the metallic calibrator blocks, so that the calibrator block is directly and the receiving body indirectly heated up.

DE 10 2008 034 361 B4 is concerned with achieving a temperature distribution within the receiving body that is as homogenous as possible, which, in detail, is to be implemented by way of a defined heat input into the receiving body. A calibrator block is not provided.

From U.S. Pat. No. 6,193,411 B1 and from US 2008/0192797 A1 it is known to directly provide the receiving body with a surrounding heating device, in order to heat up the receiving body as quickly as possible. Here, the metallic receiving body with the surrounding heating device is mounted in a housing with an insulating material. Regarding the arrangement of the heating device it is also known from US 2008/0192797 A1 to provide grooves in the outer wall of the receiving body, in which wires serving as a heating device can run, which are to ensure a correspondingly determined heat input.

For a calibration process, such calibrator blocks must be substantially heated up to the desired calibration temperature, more specifically when made of metal. Due to the mass of such a metal block, this involves considerable energy and time consumption. This means that when the calibrator block is made of a thermally conductive metal, a thermally conductive material being as a rule also electrically conductive, it must be ensured that for the actual calibration process this calibrator block has, at least in the area of the cavity, a temperature that corresponds to the calibration temperature, i.e. substantially to the temperature in the receiving body. The longer the temperature is maintained constant in the receiving body during the time period required for calibration, the more precise the calibration. This is commonly the case when a great mass has been heated up to a certain temperature. In this respect, the calibrator block is more specifically made of metal.

It has already been pointed out that directly heating up the receiving body is known from the prior art. It is known that different receiving bodies must be provided for different temperature measurement devices. In this respect, disposing heating devices on the respective receiving body for the corresponding temperature measurement devices causes a considerable effort, which leads to an increase in the cost of such receiving bodies.

### SUMMARY OF THE INVENTION

The problem underlying the invention therefore consists in providing a calibration device in which, on the one hand, a uniform, i.e. homogenous temperature distribution is provided for in the receiving body for calibrating the temperature measurement device. Additionally, a plurality of different temperature measurement devices can be calibrated in such a calibrator block with relatively little effort. The time cycles for calibrating different temperature measurement devices can moreover be kept at a minimum.

It is more specifically provided that the calibration device comprises a calibrator block with a cavity as well as a receiving body that is insertable into the cavity and is exchangeable. The calibrator block comprises a material with thermally insulating properties, whereas the receiving body, which serves to receive the temperature measurement devices to be calibrated, comprises a material with thermally conductive properties. Here, the calibrator block features at least one heating device in the area of the cavity, which serves to heat up the receiving body. It is essential for the invention that the calibrator block is made on the one hand of a thermally insulating material, wherein thermally insulating materials often also have electrically insulating properties on the other hand and moreover that by embedding the heating device in the circumferential surface of the cavity an optimal heat transfer is ensured. The embedment leads to a direct intensive connection between the heating device and the calibrator block thus generating an optimal heat transfer to the receiving body.

In this context, forming the calibrator block from a ceramic material or a ceramic-like material is conceivable, wherein a material that is similar to a ceramic is to be understood e.g. as a glass, a glass-fibre composite material or a porcelain material. Incidentally it is also conceivable to manufacture the calibrator block from a plastic material, for example a polyethylene material, i.e. a plastic that is temperature-resistant at high temperatures. Since the calibrator block is made from an insulating material, the receiving body is heated much more quickly, since the heat is not absorbed by the insulating body formed by the calibrator block. Surprisingly it has turned out that the temperature distribution remains stable in the receiving body along the length of the receiving body in spite of its small mass over a period of time that is sufficient for calibration. In this respect, it becomes possible to provide several exchangeable receiving bodies for one calibrator block, the individual receiving bodies being configured in such a manner that they can receive different temperature measurement devices.

In practical terms this makes it possible for technicians, who must carry out a calibration of such a temperature measurement device on location at a customer's premises, to merely carry along a plurality of receiving bodies, which are adapted to the different temperature measurement devices, in order to exchange them in the calibrator block if necessary. Such receiving bodies are manufacturable at substantially low cost since, as is also taught by the present invention, the calibrator block holds the at least one heating device in the area of the cavity. Conversely, this means that as opposed to what is known from the prior art, the receiving bodies are not equipped with the heating device.

Thus it is more specifically provided that the at least one heating device is disposed in an embedded manner in the circumferential surface of the cavity in a manner resulting in a substantially uniform and homogenous temperature distribution within the receiving body along the length of the receiving body. The consequence of this is for example that the heating devices have greater dimensions at the top and bottom end of the receiving body than in the middle of the length of the receiving body.

In more detail, the heating device is designed as an electrically conductive structure, for example as a heating coil, the electrically conductive structure being electrically insulated relative to the receiving body, which is made of a thermally conductive material, i.e. more specifically of a metallic material. The electric insulation is caused by the fact that due to the embedment in the material of the circumferential surface of the calibrator block, the material of the calibrator block covers the electrically conductive structure with a thin layer relative to the receiving body.

It has already been pointed out that the calibrator block can be made of a ceramic material, but also of glass, i.e. a ceramic-like material. According to a particularly advantageous feature, it is provided, more specifically when using a ceramic material for manufacturing the calibrator block, that the heating coils made of an electrically conductive material are imprinted onto the ceramic foil. The ceramic foil is provided in the form of a green compact which is baked into the circumferential surface of the cavity of the calibrator block during the sintering process, i.e. the foil being embedded into the circumferential surface of the cavity during the sintering process. In this respect, the calibrator block and the heating coil are hereby manufacturable as a homogenous unit. However, the heating device as an electrically conductive structure can also be imprinted onto the circumferential surface of the cavity before sintering and be covered for electric insulation e.g. by a ceramic foil and be then sintered with the ceramic calibrator block as has already been explained with regard to the printed foil. In order to ensure an optimal heat transfer between the calibrator block and the receiving body in the area of the heating device, the receiving body rests against the circumferential surface of the calibrator block.

According to a particularly advantageous feature, the calibrator block is equipped with at least one temperature sensor in the area of the cavity. Specifically, the temperature sensor can be configured as an electrically conductive structure. This also means that the electrically conductive structure, i.e. more specifically the heating coils, can form the temperature sensor. However, the temperature sensor can also be formed by a separate electrically conductive structure in the form of metallic conductive coils.

In the following, the invention is exemplarily described in more detail based on the drawings.

### BRIEF DESCRIPTION OF THE DRAWINGS

FIG. 1 is a schematic view of a the calibrator with a calibrating device;

FIG. 2 is a top view of the calibrating device in a top view; and

FIG. 3 is a view of a ceramic foil with imprinted heating coils and an imprinted temperature sensor also configured as a coil for arrangement on the circumferential surface of the cavity of the calibrator block.

### DETAILED DESCRIPTION OF THE INVENTION

The calibrator labelled 1 as a whole comprises a housing 2 with a circuit board 3 and a transformer 4 disposed in the housing. The circuit board 3 is connected to a control system, the housing additionally comprising a line filter with a female connector and a fuse as well as a switch, this constructional unit being labelled 6. In addition, the housing 2 contains the calibrating device labelled 10 with the calibrator block 13 made of a ceramic material. This ceramic calibrator block 13 comprises a cavity 15, the cavity 15 serving to receive the receiving body 20, the receiving body ultimately serving to receive the temperature measurement devices that are to be calibrated. The receiving body 20 is composed of a thermally conductive metal, whereas the calibrator block is composed more specifically of a ceramic material that only has a low conductivity, e.g. a ceramic. The at least one heating device 14 is located in the area of the circumferential surface 16 of the cavity 15. The heating device 14, more specifically in the form of electric heating coils, is preferably embedded as an electrically conductive structure in the circumferential surface in such a manner that it fits flush with the outer skin of the circumferential surface, so that the receiving body 20 is in immediate contact with the heating device or the calibrator block. This can be implemented by pressing, i.e. embedding the heating device, e.g. heating coils, as electrically conductive structures in the material of the calibrator block. The material of the calibrator block i.e. a ceramic for example, covers the coils in an electrically insulating manner on the side facing the receiving body. This means that the ceramic body is fitted as a green compact with the heating coils and is subsequently sintered or baked. However, it is also conceivable, and this is the object of FIG. 3, to provide a ceramic foil 19 as a green compact, this ceramic foil 19 being deposited on the circumferential surface 16 of the cavity, i.e. being baked onto the circumferential surface during manufacture of the calibrator block. The ceramic foil 19 features heating coils 15a, 15b, the heating coils being printed onto the ceramic foil.

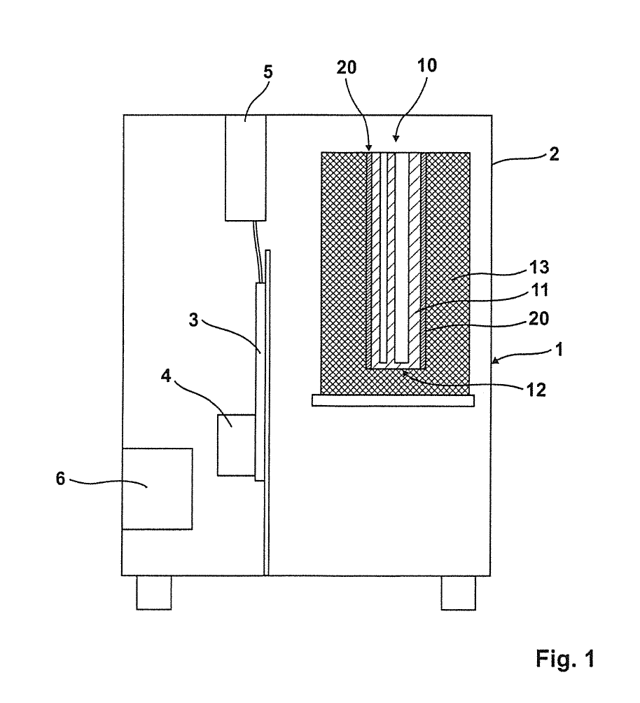

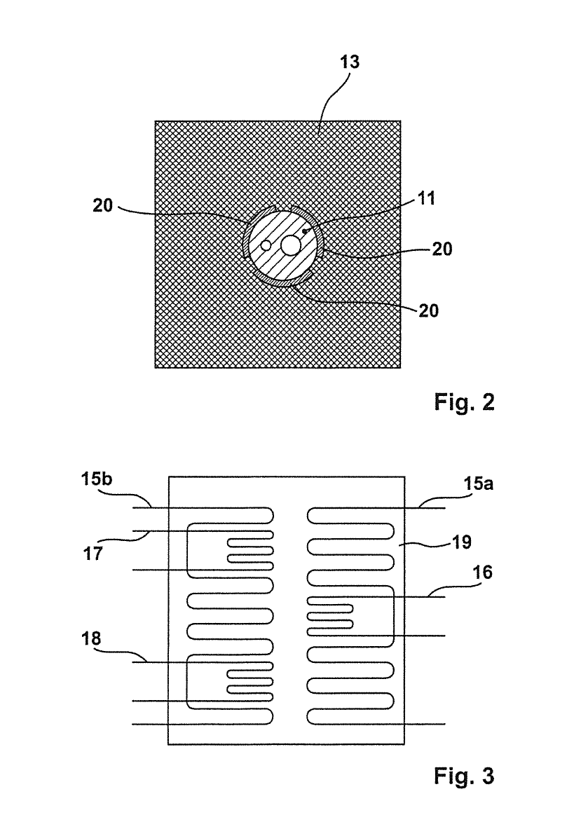

According to FIG. 1, the temperature sensors 17 and 18 are formed as coils in an electrically conductive material. When the heating coils and the temperature sensors formed as coils are respectively imprinted separately onto a ceramic foil for example, it must be provided that the temperature coils 17, 18 are distributed on the receiving body between the heating coils along the length of the receiving body. In particular, this embodiment makes it possible to determine the respective temperature along the entire length of the receiving body and at the same time to achieve a substantially uniform homogenous temperature distribution along the entire length of the receiving body. The foil is here applied with the imprinted coil or coils onto the circumferential surface 16 of the cavity in such a manner that the imprinted coils point toward the circumferential surface and the rear side of the ceramic foil forms an electric insulation against the receiving body manufactured from a metallic material.

### LIST OF REFERENCE NUMBERS

1 calibrator

2 housing

3 circuit board

4 transformer

6 constructional unit

10 calibrating device

13 calibrator block

14 heating device

15 cavity

15a heating coil

15b heating coil

16 circumferential surface

17 temperature sensor shaped as a coil

18 temperature sensor shaped as a coil

19 ceramic foil

20 receiving body

1-11. (canceled)

12. A calibration device for calibrating a device having a temperature function, the calibration device comprising:
a calibrator block having a cavity defined therein, the calibrator block being at least partially formed of a material with thermally insulating properties;
a receiving body disposed in the cavity in the calibrator block, the receiving body configured to receive at least one temperature measurement device for calibration, the receiving body being at least partially formed of a material with thermally conductive properties; and
at least one heating device embedded in the calibrator block in the area of the cavity.

13. A calibration device in accordance with claim 12, wherein:
the cavity has a circumferential surface; and
the at least one heating device is embedded in the circumferential surface such that the receiving body has a substantially homogeneous temperature distribution along a length of the receiving body.

14. A calibration device in accordance with claim 12, wherein the at least one heating device is an electrically conductive structure.

15. A calibration device in accordance with claim 14, wherein the electrically conductive structure is electrically insulated from the receiving body.

16. A calibration device in accordance with claim 14, wherein the electrically conductive structure is a heating coil.

17. A calibration device in accordance with claim 12, wherein the calibrator block is formed of a ceramic material or a ceramic-like material.

18. A calibration device in accordance with claim 17, wherein the material is glass.

19. A calibration device in accordance with claim 12, wherein the at least one heating device comprises heating coils printed onto a ceramic foil.

20. A calibration device in accordance with claim 19, wherein the ceramic foil is provided in the form of a green compact that is baked onto a circumferential surface of the cavity of the calibrator block.

21. A calibration device in accordance with claim 12, wherein the calibrator block further comprises at least one temperature sensor in the area of the cavity.

22. A calibration device in accordance with claim 21, wherein the temperature sensor is a coil.

23. A calibration device in accordance with claim 16, wherein the heating coil is further configured as a temperature sensor.
